(19) United States
(12) Patent Application Publication
(10) Pub. No.: US 2022/0264919 A1
(43) Pub. Date: Aug. 25, 2022

(54) PREPARATION METHOD OF DRIED SCALLOP

(71) Applicant: ZHEJIANG OCEAN UNIVERSITY, Zhoushan (CN)

(72) Inventors: SHANGGUI DENG, ZHOUSHAN (CN); HUIMIN LIN, ZHOUSHAN (CN); XIAOGUO YING, ZHOUSHAN (CN); YUANPEI GAO, ZHOUSHAN (CN); PENGXIANG YUAN, ZHOUSHAN (CN)

(21) Appl. No.: 17/744,417

(22) Filed: May 13, 2022

Related U.S. Application Data
(63) Continuation of application No. PCT/CN2021/072963, filed on Jan. 21, 2021.

(30) Foreign Application Priority Data
Jan. 13, 2021 (CN) 2021100412641

(51) Int. Cl. A23L 17/40; A23B 4/033; A23B 4/023

(52) U.S. Cl. CPC A23L 17/40; A23B 4/033; A23B 4/0235; A23V 2002/00

(57) ABSTRACT

A preparation method of dried scallop is provided and includes: pretreating scallops, impregnating the pretreated scallops with one of the mixed solution of konjac glucomannan and sodium salt, the mixed solution of carrageenan and sodium salt, and the mixed solution of sodium alginate and sodium salt; and then drying the impregnated scallop. The preparation method effectively prevents scallop from cracking, scattering and other quality deterioration during high-temperature drying. The dried scallop processed in this way presents a high rehydration rate. After rehydration, the dried scallop has moderate hardness, high elasticity and good color, good quality and good flavor.

### CROSS-REFERENCE TO RELATED APPLICATION

This application claims priority to Chinese Patent Application No. CN 202110041264.1, filed on Jan. 13, 2021, the contents of which are hereby incorporated by reference.

### TECHNICAL FIELD

The disclosure relates to the technical field of food processing, and in particular to a preparation method of dried scallop.

### BACKGROUND

Scallop is an important economic marine resource in China, which is popular among consumers owing to its characteristics such as low fat and high protein. However, the fresh scallop is perishable and unsuitable for long-term storage, so the fresh one is often made into the dried scallop for preservation, and the dried scallop is edible after rehydration. A conventional method is to dry scallop after soaking the scallop in salt water, but this method easily leads to cracking or even scattering of the scallop after drying, which significantly affects its appearance and economic value.

China is rich in shellfish resources, of which the common ones are Chlamys farreri, Argopecten irradians and Mizuhopecten yessoensis. In many coastal cities, mudflat characteristic culture of Argopecten irradians has become a pillar industry to promote the development of local coastal fishery economy and to increase fishermen's income. With the improvement of living standard, people are increasingly aware of the importance of food nutrition and food safety. The scallop, as a low-fat, high-protein and nutritionally balanced food, is increasingly valued by consumers. As harvest period of scallop is obviously seasonal and regional, and scallop only can be raised for a short time after fishing, it is strongly necessary to process scallop in time. The scallop is mainly frozen or dried for primary processing, transportation and storage, but these methods directly affect the quality and edible value of scallop, which restrict the development of scallop industry. Besides, frozen fresh-keeping makes the meat easy to age, the water holding capacity of the meat is low, there is a sense of residue when eating, and it is easy to change color and taste, which significantly reduces the quality of scallop products. Therefore, rational utilization of scallop resources, in-depth research and comprehensive utilization of scallop drying processing technology are urgent tasks to improve the level of aquatic product processing technology and promote the development of fishery economy in China.

### SUMMARY

The objective of the disclosure is to provide a preparation method of dried scallop, which adopts a mixed solution of konjac glucomannan (KGM) and sodium salt, a mixed solution of carrageenan (CA) and sodium salt, and a mixed solution of sodium alginate (SA) and sodium salt to pretreat the scallop. The method effectively improves qualities, colors and flavors of dried scallop and rehydrated dried scallop.

To achieve the above objective, the disclosure provides the following schemes.

The disclosure provides a preparation method of dried scallop, which includes following steps: pretreating scallop, impregnating the scallops with an impregnation solution, and then drying the impregnated scallop;

the impregnation solution includes one of the mixed solution of konjac glucomannan and sodium salt, the mixed solution of carrageenan and sodium salt, and the mixed solution of sodium alginate and sodium salt.

In an embodiment, a scallop pretreatment process includes shelling and eviscerating fresh scallops, taking and cleaning adductor muscles.

In an embodiment, the impregnating temperature is 2-6° C. and the impregnating duration is 20-40 minutes.

In an embodiment, the sodium salt includes at least one of NaCl and NaNO₃.

In an embodiment, the mixed solution of 0.2%-0.5% konjac glucomannan (mass concentration) and 3% sodium salt solution (mass concentration) is used for impregnation treatment.

In an embodiment, the mixed solution of 0.2%-0.5% carrageenan (mass concentration) and 3% sodium salt solution (mass concentration) is used for impregnation treatment.

In an embodiment, the mixed solution of 0.2%-0.5% sodium alginate (mass concentration) and 3% sodium salt solution (mass concentration) is used for impregnation treatment.

In an embodiment, the drying temperature is 70-90° C. and the drying duration is 4-8 hours. There is a temperature difference between the inside and outside of the scallop muscle during drying; the temperature difference causes uneven water loss inside and outside which leads to a great internal stress, resulting in different degrees of fracture. In addition, Maillard reaction during drying also easily leads to protein aggregation and fracture. Moreover, a high-quality gel structure formed between KGM and protein may have certain dehydration resistance during heating, resulting in the protein fracture. Therefore, in embodiment 3, a gel film on the scallop surface hinders loss of water, resulting in certain degree of fracture. KGM treatment group has higher fracture degree, more curls, and also higher tightness, which is due to denaturation of protein during scallop drying. The degeneration of protein constructs an interaction between proteins and leads to the protein aggregation. While, embodiment 2 has the highest fiber structural integrity.

The disclosure discloses the following technical effects.

In the processing process, the method according to the disclosure is used to destroy the structure of scallop and fully release betaine, various amino acids, ATP and other ingredients, which improve the taste of scallop. The protein and KGM form a three-dimensional network structure which is help to lock water, and the sodium ions can enhance the interaction between proteins in dried scallop, these together enhance the gel property of dried scallop, appropriately increase whiteness of dried scallop and improve the browning phenomenon of dried scallop after drying. The processing method according to the disclosure effectively prevents the quality deterioration of dried scallop such as cracking, scattering drying process in a high-temperature. The dried scallop processed in this way has a higher rehydration rate. The dried scallop has moderate hardness, high elasticity and good color, good quality and good flavor after rehydration.

### BRIEF DESCRIPTION OF THE FIGURES

In order to more clearly explain the embodiments of the disclosure or the technical schemes in the prior art, the following will briefly introduce the drawings that need to be used in the embodiments. Obviously, the drawings in the following description are only some embodiments of the disclosure. For those skilled in the art, other drawings can be obtained according to these drawings without any creative labor.

FIG. 1 is a 2000× scanning electron microscope graph (10 μm) of dried scallops prepared in embodiment 1.

FIG. 2 is a 2000× scanning electron microscope graph (10 μm) of dried scallops prepared in embodiment 4.

### DETAILED DESCRIPTION OF THE EMBODIMENTS

Now, various exemplary embodiments of the disclosure will be described in detail. This detailed description should not be considered as a limitation of the disclosure, but rather as a more detailed description of some aspects, features and embodiments of the disclosure.

It should be understood that the terms mentioned in the disclosure are only used to describe specific embodiments, and are not used to limit the disclosure. In addition, for the numerical range in the disclosure, it should be understood that each intermediate value between the upper limit and the lower limit of the range is also specifically disclosed. Every smaller range between any stated value or the intermediate value within the stated range and any other stated value or the intermediate value within the stated range is also included in the disclosure. The upper and lower limits of these smaller ranges can be independently included or excluded from the range.

Unless otherwise stated, all technical and scientific terms used herein have the same meanings commonly understood by those of ordinary skill in the field to which this application relates. Although the disclosure only describes preferred methods and materials, any methods and materials similar or equivalent to these described herein can be used in the practice or testing of the disclosure. All documents mentioned in this specification are incorporated by reference to disclose and describe the methods and/or materials related to the documents. In case of conflicting with any incorporated documents, the contents of this specification shall prevail.

Without departing from the scope or spirit of the disclosure, it is obvious to those skilled in the art that many modifications and changes can be made to the specific embodiments of the disclosure. Other embodiments obtained from the description of the disclosure will be obvious to those skilled in the art. The description and embodiments of that disclosure are only exemplary.

As used in this paper, the terms “including”, “comprising”, “having” and “containing” are all open terms, meaning including but not limited to.

Scallops used in the embodiments of the disclosure are fresh Argopecten irradians, which were purchased from a local market in Zhoushan, Zhejiang province, China. Konjac glucomannan (KGM) (purity>95%) was purchased from Chinese Xi'an Zelang Silicon Technology Co., Ltd., carrageenan (CA) (purity>99%) and sodium alginate (SA) (purity>99%) were purchased from Chinese Jiangsu Baiyao Biotechnology Co., Ltd., and an oven was purchased from Shanghai Yiheng Technology Co., Ltd.

### Embodiment 1

Scallops (about 0.0375 kg with shell) were shelled and eviscerated, and adductor muscles were taken and washed with distilled water; the adductor muscles were soaked in the mixed solution of 0.2% konjac glucomannan (mass concentration) and 3% NaCl (w/v) at 4° C. for 30 minutes, and the soaked adductor muscles were dried in the oven at 80° C. for 6 hours to prepare dried scallops.

### Embodiment 2

Scallops (about 0.0375 kg with shell) were shelled and eviscerated, and adductor muscles were taken and washed with distilled water; the adductor muscles were soaked in the mixed solution of 0.2% carrageenan (mass concentration) and 3% NaCl (w/v) at 4° C. for 30 minutes, and the soaked adductor muscles were dried in the oven at 80° C. for 6 hours to prepare dried scallops.

### Embodiment 3

Scallops (about 0.0375 kg with shell) were shelled and eviscerated, and adductor muscles were taken and washed with distilled water; the adductor muscles were soaked in the mixed solution of 0.2% sodium alginate (mass concentration) and 3% NaCl (w/v) at 4° C. for 30 minutes, and the soaked adductor muscles were dried in the oven at 80° C. for 6 hours to prepare dried scallops.

### Embodiment 4

Scallops (about 0.0375 kg with shell) were shelled and eviscerated, and adductor muscles were taken and washed with distilled water; the adductor muscles were soaked in 3% NaCl (w/v) solution at 4° C. for 30 minutes, and the soaked adductor muscles were dried in the oven at 80° C. for 6 hours to prepare dried scallops.

### Embodiment 5

Scallops (about 0.0370 kg with shell) were shelled and eviscerated, and adductor muscles were taken and washed with distilled water; the adductor muscles were soaked in the mixed solution of 0.3% konjac glucomannan (mass concentration) and 3% NaCl (w/v) at 4° C. for 30 minutes, and the soaked adductor muscles were dried in the oven at 80° C. for 6 hours to prepare dried scallops.

### Embodiment 6

Scallops (about 0.0370 kg with shell) were shelled and eviscerated, and adductor muscles were taken and washed with distilled water; the adductor muscles were soaked in the mixed solution of 0.4% konjac glucomannan solution (mass concentration) and 3% NaCl (w/v) solution at 4° C. for 30 minutes, and the soaked adductor muscles were dried in the oven at 80° C. for 6 hours to prepare scallops.

### Embodiment 7

Scallops (about 0.0370 kg with shell) were shelled and eviscerated, and adductor muscles were taken and washed with distilled water; the adductor muscles were soaked in the mixed solution of of 0.5% konjac glucomannan (mass concentration) and 3% NaCl (w/v) at 4° C. for 30 minutes, and the soaked adductor muscles are dried in the oven at 80° C. for 6 hours to prepare dried scallops.

### Embodiment 8

Scallops (about 0.0370 kg with shell) were shelled and eviscerated, and adductor muscles were taken and washed with distilled water; the adductor muscles were soaked in the mixed solution of 0.2% konjac glucomannan (mass concentration) and 3% NaCl (w/v) at 4° C. for 30 minutes, and the soaked adductor muscles were dried in the oven at 70° C. for 6 hours to prepare dried scallops.

### Embodiment 9

Scallops (about 0.0370 kg with shell) were shelled and eviscerated, and adductor muscles were taken and washed with distilled water; the adductor muscles were soaked in the mixed solution of 0.2% konjac glucomannan (mass concentration) and 3% NaCl (w/v) at 4° C. for 30 minutes, and the soaked adductor muscles were dried in the oven at 90° C. for 6 hours to prepare dried scallops.

### Embodiment 10

Scallops (about 0.0370 kg with shell) were shelled and eviscerated, and adductor muscles were taken and washed with distilled water; the adductor muscles were soaked in the mixed solution of 0.2% konjac glucomannan (mass concentration) and 3% NaCl (w/v) at 4° C. for 30 minutes, and the soaked adductor muscles were dried in the oven at 80° C. for 4 hours to prepare dried scallops.

### Embodiment 11

Scallops (about 0.0370 kg with shell) were shelled and eviscerated, and adductor muscles were taken and washed with distilled water; the adductor muscles were soaked in the mixed solution of 0.2% konjac glucomannan (mass concentration) and 3% NaCl (w/v) at 4° C. for 30 minutes, and the soaked adductor muscles were dried in the oven at 80° C. for 8 hours to prepare dried scallops.

### Embodiment 12

Scallops (about 0.0370 kg with shell) were shelled and eviscerated, and adductor muscles were taken and washed with distilled water; the adductor muscles were soaked in the mixed solution of 0.3%carrageenan (mass concentration) and 3% NaCl (w/v) at 4° C. for 30 minutes, and the soaked adductor muscles were dried in the oven at 80° C. for 6 hours to prepare dried scallops.

### Embodiment 13

Scallops (about 0.0370 kg with shell) were shelled and eviscerated, and adductor muscles were taken and washed with distilled water; the adductor muscles were soaked in the mixed solution of 0.4% carrageenan (mass concentration) and 3% NaCl (w/v) at 4° C. for 30 minutes, and the soaked adductor muscles were dried in the oven at 80° C. for 6 hours to prepare dried scallops.

### Embodiment 14

Scallops (about 0.0370 kg with shell) were shelled and eviscerated, and adductor muscles were taken and washed with distilled water; the adductor muscles were soaked in the mixed solution of 0.5% carrageenan (mass concentration) and 3% NaCl (w/v) at 4° C. for 30 minutes, and the soaked adductor muscles were dried in the oven at 80° C. for 6 hours to prepare dried scallops.

### Embodiment 15

Scallops (about 0.0370 kg with shell) were shelled and eviscerated, and adductor muscles were taken and washed with distilled water; the adductor muscles were soaked in the mixed solution of 0.3% sodium alginate (mass concentration) and 3% NaCl (w/v) at 4° C. for 30 minutes, and the soaked adductor muscles were dried in the oven at 80° C. for 6 hours to prepare dried scallops.

### Embodiment 16

Scallops (about 0.0370 kg with shell) were shelled and eviscerated, and adductor muscles were taken and washed with distilled water; the adductor muscles were soaked in the mixed solution of 0.4% sodium alginate(mass concentration) and 3% NaCl (w/v) at 4° C. for 30 minutes, and the soaked adductor muscles were dried in the oven at 80° C. for 6 hours to prepare dried scallops.

### Embodiment 17

Scallops (about 0.0370 kg with shell) were shelled and eviscerated, and adductor muscles were taken and washed with distilled water; the adductor muscles were soaked in the mixed solution of 0.5% sodium alginate (mass concentration) and 3% NaCl (w/v) at 4° C. for 30 minutes, and the soaked adductor muscles were dried in the oven at 80° C. for 6 hours to prepare dried scallops.

### Embodiment 18

Scallops (about 0.0370 kg with shell) were shelled and eviscerated, and adductor muscles were taken and washed with distilled water; the adductor muscles were soaked in the 0.3% mixed solution of sodium alginate (mass concentration) and 3% NaNO3 (w/v) at 4° C. for 30 minutes, and the soaked adductor muscles were dried in the oven at 70° C. for 6 hours to prepare dried scallops.

### Embodiment 19

Scallops (about 0.0370 kg with shell) were shelled and eviscerated, and adductor muscles were taken and washed with distilled water; the adductor muscles were soaked in the mixed solution of 0.2% sodium alginate (mass concentration) and 3% NaCl (w/v) at 4° C. for 30 minutes, and the soaked adductor muscles were dried in the oven at 90° C. for 6 hours to prepare dried scallops.

### Embodiment 20

Scallops (about 0.0370 kg with shell) were shelled and eviscerated, and adductor muscles were taken and washed with distilled water; the adductor muscles were soaked in the mixed solution of 0.2% carrageenan (mass concentration) and 3% NaCl (w/v) at 2° C. for 40 minutes, and the soaked adductor muscles were dried in the oven at 70° C. for 6 hours to prepare dried scallops.

### Embodiment 21

Scallops (about 0.0370 kg with shell) were shelled and eviscerated, and adductor muscles were taken and washed with distilled water; the adductor muscles were soaked in the mixed solution of 0.2% carrageenan (mass concentration) and 3% NaCl (w/v) at 6° C. for 20 minutes, and the soaked adductor muscles were dried in the oven at 90° C. for 6 hours to prepare dried scallops.

The dried scallops prepared in embodiments 1-4 were soaked in purified water at 25° C. for 2 hours to rehydrate, and properties of the dried scallops were determined. The specific process was as follows.

### I. Measurement of Water Content and Rehydration Rate

The water content was determined according to GB5009.3-2016 Determination Method of Water Content in Food.

Determination of rehydration rate: the dried scallop samples of embodiments 1-4 were soaked in 100 mL distilled water for 2 hours, the rehydrated samples were absorbed the excess water of the surfaces of the samples with filter papers then were weighed, the rehydration rate was calculated by formula (1):

$$R R = \frac{W r}{W d} \times 100 \% , \qquad ( 1 )$$

RR is the rehydration rate, Wr is a sample quality after rehydration, and Wd is the quality of the dried scallop before drying, i.e., the quality of the fresh scallop.

Results of water contents and rehydration rates of embodiment 1 to embodiment 4 are shown in Table 1.

TABLE 1
Results of water contents and rehydration
rates of embodiment 1 to 4

| Embodiment | Water content/% | Rehydration rate/% |
|---|---|---|
| Embodiment 4 | 76.06 ± 2.17^{ab} | 88.73 ± 0.12^{a} |
| Embodiment 1 (KGM) | 73.93 ± 1.06^{bc} | 90.83 ± 0.15^{a} |
| Embodiment 2 (CA) | 77.25 ± 1.34^{a} | 85.47 ± 0.07^{b} |
| Embodiment 3 (SA) | 73.13 ± 2.51^{c} | 89.73 ± 0.17^{a} |

Note:
The values of different superscript (a-c) are significantly different (P < 0.05).

It can be seen from Table 1 that the water contents of the dried scallops in embodiment 4, embodiment 1, embodiment 2 and embodiment 3 after rehydration are 76.06±2.17%, 73.93±1.06%, 77.25±1.34% and 73.13±2.51% respectively, and the rehydration rates are 88.73±0.12, 90.83±0.15, 85.47±0.07 and 89.73±0.17 respectively. The water contents of embodiments 1 and 3 are lower than that of embodiment 4 (P<0.05). However, the rehydration rates (RR) of embodiments 1 and 3 are higher than that of embodiment 4, but there are no significant differences between the groups (P>0.05). It is because a complex gel structure formed by konjac glucomannan and myofibrillar protein has strong binding force to water, which increases the retention rate of water in the gel. In addition, sodium alginate is an excellent water-retaining agent, which has stronger hydrophilicity. In embodiment 2, the water content is the highest and the rehydration rate is the lowest (P<0.05). One reason is that carrageenan dissolves in water to form hydrophilic gel, which adheres to the surface of scallop muscle and solidifies during drying. This solidified layer reduces the water absorption capacity of the scallop muscle, thus the rehydration rate of the scallop muscle is reduced. Therefore, the carrageenan can significantly reduce the water loss rate of meat gel and effectively improve water retention of the meat gel.

### II. Color Difference Measurement

Color difference values were measured by a colorimeter (CM-5; KonicaMinolta, Tokyo, Japan) under natural light. Luminance, redness, greenness, yellowness and blueness are represented by L*, +a*, −a*, +b* and −b* respectively, a total color-difference value was evaluated by ΔE*, ΔE*=[(ΔL*)²+(Δa*)²+(Δb*)²]^{1/2}. There were 6 samples in each group, each sample was measured 3 times, and the average value was taken. The results are shown in Table 2.

TABLE 2
Results of color difference of embodiment 1 to 4

| | Color parameter | | | |
|---|---|---|---|---|
| | L* | a* | b* | ΔE |
| Embod- | 72.68 ± 1.29a | −0.46 ± 1.41ab | 9.22 ± 1.77a | 73.29 ± 1.28a |
| iment 4 | | | | |
| Embod- | 73.39 ± 1.92a | −0.87 ± 1.21ab | 9.61 ± 2.22a | 74.45 ± 1.97a |
| iment 1 | | | | |
| Embod- | 73.43 ± 0.69a | −1.43 ± 0.44b | 6.55 ± 0.69b | 73.74 ± 0.69a |
| iment 2 | | | | |
| Embod- | 72.58 ± 1.42a | 0.59 ± 1.65a | 10.32 ± 2.49a | 73.36 ± 1.26a |
| iment 3 | | | | |

As can be seen from Table 2, there is no significant difference in the L* values of all samples. There are no significant differences (P>0.05) in the differences of a* values among the four groups of samples. However, the a* values are significantly different between embodiments 2 and 3 (P<0.05). The a* value of the sample is decreased and the color turns green in embodiment 3, while the a* value of the sample is increased and the color turns red in embodiment 2. After pretreatment with carrageenan, the b* values of samples are significantly different from embodiment 4, 1 and 2 (P<0.05), and the b* values of embodiment 4, 1 and 2 decrease significantly. With the increase of agar or carrageenan concentration, yellowness tends to decrease. After KGM is added, the a* values of gel samples are higher, while the L* and b* values are lower. This result is due to the Maillard reaction of amino and carbonyl groups in muscle protein, which deepens the yellowness on the surface of scallop muscle and improves the quality of scallop muscle.

### III. Microstructure

A scanning electron microscope (SEM) was used to observe the cross sections and vertical sections of scallops prepared in embodiments 1-4. The samples were cut into a size of 1 mm×1 mm×3 mm and fixed with 2.5% glutaraldehyde solution, the fixed samples were washed with phosphate buffer and dehydrated with different concentrations of ethanol gradient, and then dried with CO₂ critically. Finally, the surfaces of the samples were sprayed with gold ions and magnified by ×500, ×2000, ×5000 times by SEM for observation (Hitachi S-4300SE, Hitachi Scientific Systems Co., Ltd., Japan).

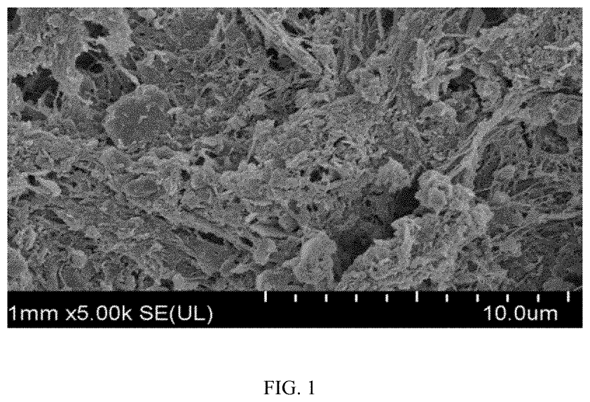

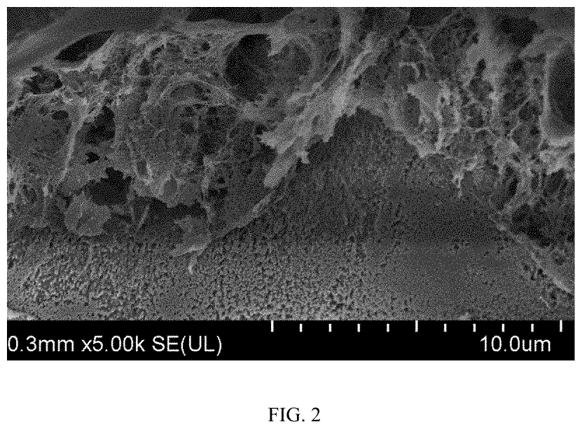

Scanning electron microscope (SEM) results of dried scallops prepared in embodiment 1 and embodiment 4 are shown in FIG. 1 and FIG. 2 respectively. As shown in the vertical section (500×), the samples of embodiment 4, 1 and 3 have different degrees of curling, of which the samples of embodiment 2 are relatively stable. Under the 2000× electron microscope, it can be seen that there are many muscle fractures and curls in embodiment 1, but slight fractures in embodiment 4, and the best effect in embodiment 2 (with almost no muscle fractures). Under the 5000× electron microscope, it can be clearly seen that all four groups of fractures have different degrees of wrinkles, and their curling degrees are as follows: embodiment 1 >embodiment 3 >embodiment 2. The fractures are closely related to the drying process of the scallops. There is a temperature difference between the inside and outside of scallop muscles during drying; the temperature difference causes uneven water loss inside and outside which result in internal stress, leading to different degrees of fracture. In addition, Maillard reaction during drying also easily leads to protein aggregation and fracture. Moreover, a high-quality gel structure formed between KGM and protein may have certain dehydration resistance during heating, resulting in the protein fracture. Therefore, in embodiment 3, a gel film on a scallop surface hinders the loss of water, resulting in a certain degree of fracture.

On the cross-sectional view (500×), there are many cracks at a white boundary in embodiments 4 and 3. The fracture degree is lighter in embodiment 1. While the muscle tissue in embodiment 2 has almost no cracks. Under the 2000× microscope, all four groups of samples are observed to have dense tissue structures. Although the obvious white gap boundary can be seen in embodiment 4, the gap does not affect the compactness of the tissue structure. In addition, the sample end in embodiment 1 has an obvious curl. At 5000× magnification, it can be clearly seen that the curling degrees of the end tissues of the samples are embodiment 1>embodiment 3>embodiment 2. This is mainly because protein and KGM are interconnected to form a dense network structure, which can lock water or other nutrients.

Therefore, the samples treated by KGM have a higher fracture degree and more curls, while also have higher tightness, it is due to the denaturation of protein during scallop drying. The degeneration of protein constructs an interaction between protein and protein and leads to the protein aggregation. Thus, the samples of embodiment 2 have the highest fiber structural integrity.

### IV. Determination of Amino Acids

The amino acid content was determined by high performance liquid chromatography (HPLC). Chromatographic conditions: KromatC18 column (250 mm×4.6 mm×5 μm), column temperature: 40° C., mobile phase A: acetonitrile, mobile phase B: 0.03 mol/L acetate buffer (pH=5.2), detection wavelength: 360 nm, flow rate: 1 m L/min, injection volume: 10 μL.

Amino acid is a basic unit of protein, the composition and content of amino acid are often used as quality indicators of fish and crustacean products. Amino acids are not only the source of seafood flavor, but also present many complex taste characteristics, such as sweetness and bitterness. Delicious amino acids (DAA) such as asparagine, glycine, alanine, arginine, glutamic acid and proline have been identified as the active ingredients of fresh scallop and the main free amino acids of boiled scallop. Glycine is closely related to the palatability of crustacean muscles, which is main affects the taste of scallop.

The amino acid contents of four groups of samples are shown in Table 3. The total amino acid content in embodiment 3 is higher than that in embodiment 4, and the total amino acid contents in embodiment 1 and embodiment 2 are lower than that in embodiment 4. Amino acids mainly come from the decomposition of protein by endogenous proteolytic enzymes. For the scallop treated with carrageenan, Na⁺ adheres to the scallop surface and affect the gel strength. During oven drying, there is a temperature difference between the inside and outside of the scallop. The scallop treated with carrageenan has endogenous enzyme activities higher than that of embodiment 4, high protein decomposition rate, and amino acid contents higher than these of embodiment 4.

TABLE 3
Results of composition and content of amino acids in embodiment 1 to 4

| | Critical | Composition (g/kg) | | | | | | | |
|---|---|---|---|---|---|---|---|---|---|
| Amino | value | Embodiment | | | | | | Sodium | |
| acid | (mg/kg) | 4 | TAV | KGM | TAV | Carrageenin | TAV | alginate | TAV |
| Asp | 1000 | 36.16 | 36.16 | 30.63 | 30.63 | 37.30 | 37.30 | 35.30 | 35.30 |
| Glu | 300 | 59.22 | 197.41 | 51.25 | 170.84 | 62.15 | 207.18 | 58.22 | 194.06 |
| Ser | 1500 | 15.06 | 10.04 | 12.94 | 8.63 | 16.12 | 10.75 | 14.75 | 9.83 |
| Gly | 1300 | 39.78 | 30.60 | 33.53 | 25.79 | 43.25 | 33.27 | 40.98 | 31.52 |
| His | 200 | 6.10 | 30.52 | 5.24 | 26.19 | 6.52 | 32.60 | 5.96 | 29.82 |
| Arg | 500 | 25.90 | 51.79 | 21.90 | 43.80 | 29.24 | 58.48 | 25.04 | 50.08 |
| Thr | 2600 | 13.86 | 5.33 | 11.79 | 4.53 | 14.55 | 5.60 | 13.37 | 5.14 |
| Ala | 600 | 20.40 | 34.00 | 17.52 | 29.20 | 21.82 | 36.37 | 19.86 | 33.10 |
| Pro | 3000 | 10.72 | 3.57 | 9.36 | 3.12 | 11.49 | 3.83 | 10.52 | 3.51 |
| Tyr | — | 10.73 | — | 9.30 | — | 11.13 | — | 10.58 | — |
| Val | 400 | 14.85 | 37.12 | 12.82 | 32.05 | 15.85 | 39.63 | 14.55 | 36.38 |
| Cys | — | 10.25 | — | 8.81 | — | 10.80 | — | 9.95 | — |
| Met | 300 | 27.74 | 92.47 | 26.11 | 87.04 | 40.73 | 135.76 | 29.24 | 97.48 |
| Ile | 900 | 14.98 | 16.65 | 12.77 | 14.19 | 16.28 | 18.09 | 14.68 | 16.31 |
| Leu | 1900 | 28.62 | 15.06 | 24.64 | 12.97 | 30.82 | 16.22 | 27.92 | 14.69 |
| Phe | 900 | 13.57 | 15.08 | 11.90 | 13.22 | 14.85 | 16.50 | 13.74 | 15.27 |
| Lys | 500 | 32.68 | 65.36 | 28.14 | 56.28 | 34.49 | 68.98 | 31.81 | 63.62 |
| TAA | — | 380.63 | — | 328.66 | — | 417.40 | — | 376.49 | — |
| TEAA | — | 178.31 | — | 155.32 | — | 203.34 | — | 176.33 | — |
| DAA | — | 181.35 | — | 155.24 | — | 192.13 | — | 179.63 | — |

### V. Determination of Betaine

Water extraction method was adopted to extract betaine. The specific method includes: The dried scallops were boiled three times with water, the amount of water was 6 times, 5 times and 4 times the mass of the dried scallops, and the boiling time was 1 hour, 1 hour and 0.5 hours respectively. After cooling, the filtrates were combined, filtered with medium-speed filter paper, and the obtained filtrate was concentrated under reduced pressure to obtain betaine. Colorimetry was used to determine the content of betaine, and the specific conditions are as follows: betaine formed a red precipitate with Raytheon's salt at pH 1; betaine was dissolved in 70% acetone, absorbance was measured at 525 nm, and then the content was found in a standard solution of betaine. TAV values are used to evaluate the taste of betaine, the analysis results are shown in Table 4.

TABLE 4
Results of betaine in embodiment 1 to 4

| | Betaine content | Threshold value | |
|---|---|---|---|
| | (mg/g) | (mg/g) | TAV |
| Embodiment 4 | 51.81 | | 20.72 |
| Embodiment 1 | 89.55 | 2.5 | 35.82 |
| Embodiment 2 | 63.34 | | 25.34 |
| Embodiment 3 | 76.68 | | 30.67 |

The content of betaine is found in high levels in crustaceans, mollusks, aquatic animals and fish. Betaine effectively increases sweetness, which is one main flavor substance in these aquatic products. As seen from Table 4, the TAV value of the sample in embodiment 2,3,4 is greater than that in embodiment 1, the TAV value in embodiment 1 is the highest (35.82), and the TAV values in embodiment 2, 3 and 4 are 30.67, 25.34 and 20.72 respectively. The result shows that the pretreatments with KGM, CA and SA effectively affect the flavor of scallops, and KGM has the greatest effect. It may be due to the stable physical and chemical properties and high temperature resistance of betaine. During processing, high temperature treatment destroys the structure of scallops, allowing the betaine to be fully released.

### VI. Determination of ATP-Related Compounds

HPLC was used for analysis. Column: COSMOSILS C₁₈-MS-II (4.6 mm×250 mm×5 μm); mobile phase: 0.05 mol/L KH₂PO₄—K₂HPO₄ buffer (containing 2% methanol, pH 6.5); flow rate: 0.6 mL/min, equal elution amount; column temperature: 25° C.; detection wavelength: 254 nm; sample volume: 20 μL. The results are shown in Table 5.

TABLE 5
Results of ATP-related compounds in embodiment 1 to 4

| ATP- | | | | | |
|---|---|---|---|---|---|
| related | | Embodiment | | | |
| com- | Threshold | Embod- | Embod- | Embod- | Embod- |
| pounds | value | iment | iment | iment | iment |
| (mg/kg) | (mg/kg) | 4 | 1 | 2 | 3 |
| ATP | — | 31.8 | ND | 96.8 | 11.7 |
| ADP | — | 152.5 | 365.2 | 716.6 | 672.7 |
| AMP | 500 | 429.3 | 124.1 | 203.2 | 251.1 |
| IMP | 250 | 717.4 | 593.6 | 880.8 | 507.7 |
| HxR | — | 458.8 | 27.849 | 127.7 | 308.1 |
| Hx | — | 271.9 | 238.9 | 102.3 | 141.7 |

In addition to amino acids, some nucleotides also enhance the overall taste of seafood. Table 5 shows that the sample of embodiment 2 has the highest ATP content of 96.8 mg/kg, while no ATP is detected in the sample of embodiment 1. The sample of embodiment 4 has the highest AMP content of 429.3 mg/kg, followed by the samples of embodiment 3, embodiment 2 and embodiment 1 (251.1 mg/kg, 203.2 mg/kg and 124.1 mg/kg respectively). The sample of embodiment 2 has the highest IMP content of 880.8 mg/kg, followed by embodiment 4, embodiment 1 and embodiment 3 (717.4 mg/kg, 593.6 mg/kg and 507.7 mg/kg, respectively), and all of the contents are higher than the threshold, which indicates that these nucleotides contribute to the flavorful effects of scallops. Generally, the decomposition pathway of ATP in shellfish after death is ATP→ADP→AMP→IMP→H_{X}R→H_{X}. AMP is a good flavoring agent in shellfish meat; IMP is a umami substance that fortifies glutamic acid, and IMP makes meat sweet and presents a strong umami taste. However, when IMP is converted into HxR and Hx, the muscle presents an unpleasant bitter taste. The sum of HxR content and Hx content in embodiment 2 is 230.0 mg/kg, which is significantly lower than other groups. However, the addition of carrageenan increases the richness of scallop flavor, improves the umami taste of scallops, and reduces the bitter taste to some extent.

### VII. Analysis of Volatile Components

GC-MS was adopted for analysis.

SPME conditions: The aging extraction head was inserted into the sample bottle and extracted at 60° C. for 30 min. Then the aging extraction head was moved into GC-MS combined sampler and desorbed at 250° C. for 3 min.

Gas chromatographic conditions: Rtx-5MS elastic capillary column (30 mm×0.25 mm×0.25 μtm); temperature programming: keeping an initial column temperature of 50° C. for 5 minutes; setting a heating rate of 5° C./min, raising the temperature to 160° C. and keeping it for 5 minutes; setting the heating rate of 10° C./min, raising the temperature to 250° C. and keeping it for 2 minutes; inlet temperature: 250° C.; air carrying capacity (He) flow rate: 1.0 mL/min.

Mass spectrometry conditions: electron energy 70 eV; interface temperature 250° C.; ion source temperature 230° C.; scanning range 40-400 um. The results are shown in Table 6.

TABLE 6
Results of GC-MS in embodiment 1 to 4

| | | | Relative quantity % | | | |
|---|---|---|---|---|---|---|
| Serial | | | Embodiment | Embodiment | Embodiment | Embodiment |
| number | Compound | CAS | 4 | 1 | 3 | 2 |
| | Acid 10 | | | | | |
| 1 | Tetradecanoic acid | 544-63-8 | 3.16 | 1.76 | ND | 2.34 |
| 2 | Pentadecanoic acid | 1002-84-2 | 0.62 | ND | ND | ND |
| 3 | n-exadecanoic acid | 57-11-4 | 0.66 | ND | ND | ND |
| 4 | n-Hexadecanoic acid | 57-10-3 | 11.16 | 9.46 | ND | 12.01 |
| 5 | n-Decanoic acid | 334-48-5 | ND | 1.36 | ND | ND |
| 6 | Docosanoic acid | 112-85-6 | ND | ND | 1.07 | ND |
| 7 | Fumaramic acid | 2987-87-3 | ND | ND | ND | 0.44 |
| 8 | Folic Acid | 59-30-3 | ND | ND | ND | 2.28 |
| 9 | 16-Hydroxyhexadecanoic | 506-13-8 | ND | ND | ND | 0.99 |
| | acid | | | | | |
| 10 | Benzenepropanoic acid | 501-52-0 | ND | ND | 0.62 | ND |
| | Aldehydes 6 | | | | | |
| 11 | Benzaldehyde | 100-52-7 | 1.36 | 1.15 | 5.09 | 0.42 |
| 12 | Benzaldehyde,2,4- | 15764-16-6 | 0.27 | ND | ND | ND |
| | dimethyl- | | | | | |
| 13 | Butanal, 3-methyl- | 590-86-3 | ND | 1.47 | ND | ND |
| 14 | 2-Heptenal, (E)- | 18829-55-5 | ND | 1.15 | ND | ND |
| 15 | Benzaldehyde, 4-(1- | 122-03-2 | ND | ND | 1.03 | ND |
| | methylethyl)- | | | | | |
| 16 | Acetaldehyde | 75-07-0 | ND | ND | 0.53 | ND |
| | Alkanes 7 | | | | | |
| 17 | Cyclotetradecane | 295-17-0 | 0.41 | ND | ND | ND |
| 18 | Nonane, 2,3-dimethyl- | 2884-06-2 | 0.64 | ND | ND | ND |
| 19 | Octadecanal | 638-66-4 | ND | 0.44 | ND | ND |
| 20 | 1-Methyl-2- | 2808-75-5 | ND | ND | ND | 0.53 |
| | methylenecyclohexane | | | | | |
| 21 | Hexadecanal | 629-80-1 | ND | ND | ND | 0.43 |
| 22 | 1,4-Octadiene | 5675-25-2 | 0.64 | ND | ND | ND |
| 23 | Cyclooctene | 931-88-4 | ND | 0.58 | ND | ND |
| | Aromatics 6 | | | | | |
| 24 | 1,1′-Biphenyl, 3,3′,4,4′- | 4920-95-0 | ND | 1.48 | ND | ND |
| | tetramethyl- | | | | | |
| 25 | 1,1′-Biphenyl, 3,4-diethyl- | 61141-66-0 | ND | ND | 0.94 | ND |
| 26 | Benzene, 1-methoxy-4-(1- | 104-46-1 | ND | ND | 1.87 | 0.36 |
| | propenyl)- | | | | | |
| 27 | Benzothiazole | 95-16-9 | 0.40 | ND | 0.74 | 1.86 |
| 28 | Benzothiazole, ,2-[1-(2- | 309742-44-7 | 1.22 | ND | ND | ND |
| | phenylethyl)-2- | | | | | |
| | benzimidazolylmethylthio]- | | | | | |
| 29 | 1,2-Benzisothiazole | 272-16-2 | ND | 0.47 | ND | ND |
| | Naphthalenes 2 | | | | | |
| 30 | Naphthalene | 91-20-3 | 1.41 | 2.22 | 1.02 | 2.12 |
| 31 | Naphthalene, 1,2,3- | 26137-53-1 | ND | ND | 0.80 | ND |
| | trimethyl-4-propenyl-, (E)- | | | | | |
| | Esters 15 | | | | | |
| 32 | Butanoic acid, butyl ester | 109-21-7 | 0.28 | 0.47 | 1.25 | ND |
| 33 | Carbamodithioic acid, | 686-07-7 | 0.98 | 1.51 | 0.75 | ND |
| | diethyl-, methyl ester | | | | | |
| 34 | Dodecanoic acid, methyl | 111-82-0 | 5.65 | ND | ND | ND |
| | ester | | | | | |
| 35 | Thiocyanic acid carbazol- | 40736-18-3 | 2.67 | 3.26 | ND | 1.93 |
| | 3,6-diyl ester | | | | | |
| 36 | Hexadecanoic acid, methyl | 112-39-0 | 7.17 | 12.96 | 8.57 | 12.83 |
| | ester | | | | | |
| 37 | Diethyl Phthalate | 84-66-2 | ND | 0.47 | ND | ND |
| 38 | Phthalic acid, isobutyl octyl | 1000309-04-5 | ND | 1.14 | ND | 0.90 |
| | ester | | | | | |
| 39 | Heptadecanoic acid, | 36617-50-2 | ND | 0.69 | ND | ND |
| | heptadecyl ester | | | | | |
| 40 | Butanoic acid, 1- | 819-97-6 | ND | ND | 0.52 | ND |
| | methylpropyl ester | | | | | |
| 41 | Benzyl Benzoate | 120-51-4 | ND | ND | 0.37 | ND |
| 42 | Decanoic acid, 1,2,3- | 621-71-6 | ND | ND | 0.97 | ND |
| | propanetriyl ester | | | | | |
| 43 | Glycerol tricaprylate | 538-23-8 | ND | ND | 3.80 | ND |
| 44 | Benzeneacetic acid, 4-(1,1- | 3549-23-3 | ND | ND | ND | 2.21 |
| | dimethylethyl)-, methyl | | | | | |
| | ester | | | | | |
| 45 | Ethyl 2- | 17435-72-2 | ND | ND | ND | 0.46 |
| | (bromomethyl)acrylate | | | | | |
| 46 | 1(3H)-Isobenzofuranone, 6- | 1552-42-7 | ND | 1.39 | ND | ND |
| | (dimethylamino)-3,3-bis[4- | | | | | |
| | (dimethylamino)phenyl]- | | | | | |
| | Furans 3 | | | | | |
| 47 | Indole | 120-72-9 | 2.65 | 3.09 | 1.77 | 3.14 |
| 48 | 1H-Indole, 3-methyl- | 83-34-1 | ND | ND | 11.05 | ND |
| 49 | 9,9-Dimethyl-9-silafluorene | 13688-68-1 | ND | ND | ND | 0.81 |
| | Alcohols 5 | | | | | |
| 50 | 4-Heptanol, 2-methyl- | 21570-35-4 | 0.92 | ND | ND | 1.14 |
| 51 | 1-Tetracosanol | 506-51-4 | ND | 0.73 | ND | ND |
| 52 | 5-Nonanol | 623-93-8 | ND | ND | 3.95 | ND |
| 53 | Menthol | 1490-04-6 | ND | ND | 1.11 | ND |
| 54 | 11-Heneicosanol | 3381-26-8 | ND | ND | | 0.37 |
| | Phenolic compounds 6 | | | | | |
| 55 | Phenol, 2-methyl-5-(1- | 499-75-2 | 0.87 | 0.69 | 1.10 | 0.76 |
| | methylethyl)- | | | | | |
| 56 | Phenol, 2,6-bis(1,1- | 128-39-2 | 3.01 | ND | ND | ND |
| | dimethylethyl)- | | | | | |
| 57 | Phenol, 2,4-bis(1,1- | 96-76-4 | ND | 4.44 | ND | ND |
| | dimethylethyl)- | | | | | |
| 58 | Phenol, 2-methoxy-4-(1- | 97-54-1 | ND | ND | 0.51 | ND |
| | propenyl)- | | | | | |
| 59 | Phenol, 3,5-bis(1,1- | 1138-52-9 | ND | ND | 6.42 | ND |
| | dimethylethyl)- | | | | | |
| 60 | Eugenol | 97-53-0 | 42.54 | 31.28 | 36.30 | 40.17 |
| | Ketones 6 | | | | | |
| 61 | Acetophenone | 98-86-2 | ND | 0.44 | 0.39 | 0.49 |
| 62 | trans-4-Dimethylamino-4′- | 52119-37-6 | ND | 0.52 | ND | ND |
| | methoxychalcone | | | | | |
| 63 | 3-Methyl-3-cyclohexen-1- | 31883-98-4 | ND | ND | 0.84 | ND |
| | one | | | | | |
| 64 | 7-Methoxy-2,3-diphenyl- | 18720-69-9 | ND | ND | 0.43 | ND |
| | 4H-chromen-4-one | | | | | |
| 65 | 2-Propanone, 1-(2- | 95047-97-5 | ND | ND | ND | 0.46 |
| | methoxycyclohexyl)- | | | | | |
| 66 | 2-Propen-1-one, 1-(4- | 2403-30-7 | 3.18 | ND | ND | ND |
| | aminophenyl)-3-phenyl- | | | | | |
| | Pyrazines 1 | | | | | |
| 67 | Pyrazine, 2,6-dimethyl- | 108-50-9 | 0.28 | ND | ND | ND |
| | Pyridines 1 | | | | | |
| 68 | 4-(4-Chlorophenyl)-2,6- | 001498-82-4 | ND | ND | 0.83 | ND |
| | diphenylpyridine | | | | | |
| | Amine 7 | | | | | |
| 69 | Benzenamine, N-ethyl- | 000103-69-5 | ND | ND | ND | 0.76 |
| 70 | 1-Tetradecanamine 1- | 002016-42-4 | ND | 0.60 | ND | ND |
| 71 | Cyclopropanecarboxamide | 6228-73-5 | 0.88 | 1.29 | ND | ND |
| 72 | Acetamide, N, N-dimethyl- | 127-19-5 | 1.80 | ND | ND | ND |
| 73 | Propanamide, 2-methyl- | 563-83-7 | 0.59 | ND | ND | ND |
| 74 | Propanamide | 79-05-0 | 0.46 | ND | ND | ND |
| 75 | Urea, N, N′-diethyl- | 000623-76-7 | ND | ND | ND | 0.65 |
| | Alkalines 3 | | | | | |
| 76 | N-(1-Cyclopenten-1-yl)- | 936-52-7 | 0.39 | ND | ND | ND |
| | morpholine | | | | | |
| 77 | Guanidine, N, N-dimethyl- | 6145-42-2 | ND | 1.24 | ND | ND |
| 78 | .alpha.-Acetyl-N,N- | 040488-01-5 | ND | 0.53 | ND | ND |
| | dinormethadol | | | | | |

Table 6 shows the results of the analysis for the volatile components of scallop muscles in embodiment 4, embodiment 1, embodiment 3 and embodiment 2. A total of 78 compounds are identified, in which esters (15 kinds) are the most, and other compounds include amines (7 kinds), acids (10 kinds), ketones (6 kinds), alkanes (10 kinds), aldehydes (6 kinds), aromatics (6 kinds), phenolic compounds (6 kinds), alcohols (5 kinds), alkalines (3 kinds), furans (3 kinds), naphthalenes (2 kinds), pyrazines (1 kind) and pyridines (1 kind).

A total of 15 esters are detected in embodiment 1 to 4, in which the content of hexadecanoic acid methyl ester is the highest, accounting for 12.96% in embodiment 1, followed by embodiment 2, embodiment 3 and embodiment 4, accounting for 12.83%, 8.57% and 7.17% respectively. Hexadecanoic acid methyl ester is one of the main aroma components of Anji white tea, which is formed by dehydration and condensation of high fatty acids and low alcohols. Butanoic acid butyl ester and carbamodithioic acid, diethyl-, methyl ester are also detected in embodiment 4, embodiment 1 and embodiment 3. Thiocyanic acid carbazol-3,6-diyl ester is detected in the other three groups except embodiment 3, its proportion in embodiment 1 is the highest at 3.26%, and its proportion in embodiment 4 and embodiment 2 is 2.67% and 1.93%, respectively. Butanoic acid butyl ester is a kind of low fatty acid ester, which is often used as a flavor additive owing to its fruit fragrance. There are unique residual esters in each group of samples, for example, dodecanoic acid methyl ester is unique to embodiment 4 (5.65%), glycerol tricaprylate is unique to embodiment 3 (3.80%), benzeneacetic acid, 4-(1,1-dimethylethyl)-, methyl ester is unique to embodiment 2 (2.21%). Notably, dodecanoic acid methyl ester and glycerol tricaprylate are important components of mushroom flavor.

A total of 6 ketones are detected in embodiment 1-4. Acetophenone is detected in embodiment 1, embodiment 3 and embodiment 2, accounting for 0.44%, 0.39% and 0.49% respectively. The only ketone detected in embodiment 4 is 2-Propen-1-one, 1-(4-aminophenyl)-3-phenyl-, which is unique to embodiment 4, accounting for 3.18%. Other ketones detected in embodiment 3 are 3-Methyl-3-cyclohexen-1-one (0.84%) and 7-Methoxy-2,3-diphenyl-4H-chromen-4-one (0.43%). Generally, ketones are derived from lipid oxidation and degradation and Maillard reaction.

A total of 10 acidic substances are detected in four groups, of which tetradecanoic acid and n-Hexadecanoic acid are detected in embodiment 4, embodiment 1 and embodiment 2. N-Hexadecanoic acid accounts for 11.16%, 9.46% and 12.01% in the three groups respectively. Tetradecanoic acid accounts for 3.16%, 1.76% and 2.34% in the three groups respectively. In addition, pentadecanoic acid (0.62%) and n-exadecanoic acid (0.66%) are detected in embodiment 4, respectively. N-Decanoic acid (1.36%) is detected separately in embodiment 1. In embodiment 3, docosanoic acid (1.07%) and benzenepropanoic acid (0.62%) are detected respectively. Fumaramic acid (0.44%), folic acid (2.28%) and 16-Hydroxyhexadecanoic acid (0.99%) are detected in embodiment 2, respectively.

A total of 6 aldehydes are detected in four groups of samples from embodiment 1-embodiment 4. Benzaldehyde is detected in all four groups. The proportion of total volatile components in embodiment 3 is the highest (5.09%), followed by embodiment 4, embodiment 1 and embodiment 2, accounting for 1.36%, 1.15% and 0.42% respectively. Benzaldehyde has a pleasant aroma of almonds, nuts and fruits, and is an important flavor component of crab meat and wild catfish. In embodiment 1, butanal, 3-methyl—(1.47%) and 2-Heptenal, (E)—(1.15%) are detected respectively. In embodiment 3, benzaldehyde, 4-(1-methylethyl)—(1.03%) and acetaldehyde (0.53%) are detected respectively. Different aldehydes have different odors, and C3C4 aldehyde has a strong odor. The C5C9 aldehyde has a fragrance of Sauropus androgynus, oil wax and putty. C10C12 aldehyde has a flavor of orange peel and lemon. These aldehydes are usually produced by lipid degradation and oxidation.

A total of 5 alcohols are detected in four groups of samples from embodiment 1-embodiment 4. 4-Heptanol, 2-methyl- is detected in embodiment 4 and embodiment 2 (0.92% and 1.14% respectively). 1-Tetracosanol (0.73%) is isolated from embodiment 1. In embodiment 3,5-Nonanol (3.95%) and menthol (1.11%) are detected respectively. In embodiment 2, only 11-Heneicosanol (0.37%) is detected. Alcohol comes from lipid oxidation and degradation.

A total of 6 phenolic compounds are detected in four groups of samples from embodiment 1-embodiment 4. Eugenol is the compound with the highest proportion among the four sample groups, accounting for 42.54%, 31.28%, 36.30% and 40.17% in embodiment 4, embodiment 1, embodiment 3 and embodiment 2, respectively. Eugenol has a particularly strong spicy, bacon-like aroma. Phenol is detected in embodiment 4 (0.87%), embodiment 1 (0.69%), embodiment 3 (1.10%) and embodiment 2 (0.76%) simultaneously. Phenolic compounds have sweet taste. Phenol, 2,4-bis(1,1-dimethylethyl) is detected in embodiment 1, accounting for 0.44%. Phenol, 2-methoxy-4-(1-propenyl) (0.51%) and Phenol, 3,5-bis(1,1-dimethylethyl) (6.42%) are detected in embodiment 3. Phenolic compounds are generally synthesized from alcohols produced by fat oxidation and esters of free fatty acids and make meat products fruity. Phenolic compounds may also come from microbial fermentation of food or scallops.

A total of 8 hydrocarbons are detected in four groups of samples from embodiment 1-embodiment 4. Cyclotetradecane (0.41%), nonane (0.64%) and 1,4-Octadiene (0.64%) are detected in embodiment 4. Octadecanal (0.44%) and cyclooctane (0.58%) are detected in embodiment 1, respectively. In embodiment 2, 1-Methyl-2-methylenecyclohexane (0.53%) and hexadecanal (0.43%) are detected respectively. Most of hydrocarbons have sweet and aromatic smells, but the general threshold is high, so these hydrocarbons don't contribute much to the smell. Hydrocarbons generally come from lipid degradation. In addition, 6 aromatic hydrocarbons are detected, and benzothiazole is detected in embodiment 4, embodiment 3 and embodiment 2 jointly, accounting for 0.40%, 0.74% and 1.86% respectively. 1,1′-Biphenyl, 3,3′,4,4′-tetramethyl- is unique to embodiment 1, accounting for 1.48%. Naphthalene is detected in embodiment 4, embodiment 1, embodiment 3 and embodiment 2, accounting for 1.41%, 2.22%, 1.02% and 2.12% respectively. Biphenyl, naphthalene and phthalic acid ester are considered as environmental pollutants. These compounds are detected in different degrees in all four groups. 1, 1-biphenyl has a pleasant, spicy, mild, geranium like and strange complex smell. Naphthalene may be a product of microbial degradation of plant materials or environmental pollutants. Olefins are considered as oxidation products of fatty acids or derived from N-6PufAs.

Heterocyclic compounds, including furan, pyridine and thiazole are detected in four groups of samples from embodiment 1 to embodiment4. Furan is mainly produced by the thermal decomposition of amino acids, fat oxidation and Maillard reaction, and often presents a meaty taste. Furan accounts for 2.65%, 3.09%, 1.77% and 3.14% in embodiment 4, embodiment 1, embodiment 3 and embodiment 2 respectively. Among them, 1H-Indole, 3-methyl- is unique to embodiment 3, accounting for 11.05%. The presence of indole indicates that microorganisms contribute to the flavor of the product. Amines are also detected, four in embodiment 4, two in embodiment 1 and two in embodiment 2. Amines usually have the rotten smell. The detection result also shows that the pretreatment combinations produce better taste than embodiment 4. Other detected compounds, such as guanidines, mostly come from protein degradation, and these compounds may be related to added sugar and processing.

After the scallop muscles are soaked and pretreated in different ways, the dried products of scallop muscles are rehydrated; the water content of the samples in the CA group is the highest, and the rehydration rate of the samples in the KGM group is the highest. In terms of color difference, there is no significant difference in the L* and ΔE values of each group of samples. The b* of scallops pretreated with CA decreases significantly. The yellowness of scallops in CA group decreases significantly compared with other groups. SEM observation shows that protein and KGM form a three-dimensional network structure, which is helpful to lock water. However, the structure is also easy to cause protein denaturation and aggregation during drying, so the degree of muscle fiber breakage and curling in KGM group is higher. To sum up, KGM has excellent water retention, while CA group has higher water content and lower yellowness.

Amino acid detection shows that CA group has the highest total amino acid content and the highest flavor amino acid content. The detection of ATP-related compounds shows that the IMP contents of the four groups of samples are all higher than the threshold value, which contributes to flavorful effects of scallops, and the IMP content of CA group is the highest. The betaine content in KGM group is the highest. In the analysis of volatile components, 78 compounds are detected, most of which are esters. Eugenol has the aroma of bacon, and the content of eugenol is the highest among the four groups of samples. The contents of hexadecanoic acid, hexadecanoic acid methyl ester, tetradecanoic acid, biphenyl and heterocyclic compounds are the second. Aldehydes that contribute greatly to the flavor of the samples are also detected in the four groups of samples from embodiment 1-embodiment 4. For example, benzaldehyde accounts for the highest proportion in CA group. At the same time, some environmental pollutants, such as naphthalene and phthalates, are detected in the samples, and these pollutants complicate the taste of scallop muscles. Through comparison and analysis, it can be seen that CA group has the highest content of total amino acids, flavor amino acids, ATP-related compounds and IMP compounds (such as benzaldehyde) that make scallop flavor outstanding.

To sum up, KGM treatment obviously improves the water retention of scallop muscles, while CA treatment has the greatest influence on scallop flavor and especially enhances the umami flavor of scallops.

The above-mentioned embodiments only describe the preferred mode of the disclosure, but do not limit the scope of the disclosure. On the premise of not departing from the design spirit of the application, all kinds of modifications and improvements made by those skilled in the art to the technical scheme of the application shall fall within the scope of protection determined by the claims of the disclosure.

What is claimed is:

1. A preparation method of dried scallops, comprising:
pretreating scallops;
impregnating the pretreated scallops with an impregnation solution; and
drying the impregnated scallops;
wherein the impregnation solution comprises one selected from the group consisting of a mixed solution of konjac glucomannan and sodium salt, a mixed solution of carrageenan and the sodium salt, and a mixed solution of sodium alginate and the sodium salt.

2. The preparation method of dried scallops according to claim 1, wherein the pretreating scallops, comprises:
shelling and eviscerating fresh the scallops, and then taking and cleaning adductor muscles.

3. The preparation method of dried scallops according to claim 1, wherein a temperature of the impregnating is in a range from 2 to 6° C., and a duration of the impregnating is in a range from 20 to 40 minutes.

4. The preparation method of dried scallops according to claim 1, wherein the sodium salt comprises at least one of NaCl and NaNO₃.

5. The preparation method of dried scallops according to claim 1, wherein the impregnating the pretreated scallops with an impregnation solution, comprises:
impregnating the pretreated scallops by using the mixed solution of the konjac glucomannan with a mass concentration of 0.2%-0.5% and the sodium salt with a mass concentration of 3%.

6. The preparation method of dried scallops according to claim 1, wherein the impregnating the pretreated scallops with an impregnation solution, comprises:
impregnating the pretreated scallops by using the mixed solution of the carrageenan with a mass concentration of 0.2%-0.5% and the sodium salt with a mass concentration of 3%.

7. The preparation method of dried scallops according to claim 1, wherein the impregnating the pretreated scallops with an impregnation solution, comprises:
impregnating the pretreated scallops by using the mixed solution of the sodium alginate with a mass concentration of 0.2%-0.5% and the sodium salt with a mass concentration of 3%.

8. The preparation method of dried scallops according to claim 1, wherein a temperature of the drying is in a range from 70 to 90° C., and a duration of the drying is in a range from 4 to 8 hours.
